(19) United States
(12) Patent Application Publication
(10) Pub. No.: US 2007/0195011 A1
(43) Pub. Date: Aug. 23, 2007

(54) Work area setting and managing system

(76) Inventors: Keiji Hatori, Ibaraki (JP); Kazuhiro Sugawara, Ibaraki (JP); Hiroshi Ogura, Ibaraki (JP); Hideto Ishibashi, Ibaraki (JP); Masaharu Ikuta, Ibaraki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/592,468

(22) PCT Filed: Mar. 11, 2005
(86) PCT No.: PCT/JP05/04284

§ 371 Date: Sep. 11, 2006

(30) Foreign Application Priority Data
Mar. 12, 2004 (JP) 2004-070928

(51) Int. Cl. G09G 5/00

(52) U.S. Cl. 345/2.1

(57) ABSTRACT

A work area setting and managing system which enables a operator to plan and manage work in a work area and set and store the work area at just the mobile work machine side at the work site is provided. The system is applied to a mobile work machine 11 performing land mine disposal work in the work area and provided with a GPS 3D position finding system and a tablet computer 62 having a display unit 63, input unit 64, and memory 65. This system is provided with a first means for displaying a work monitor screen 90 on a screen of the display unit, a second means for displaying a symbol of the mobile work machine on the work monitor screen based on positional coordinates of an attachment of the mobile work machine obtained by the GPS 3D position finding system, and a third means for preparing a work area based on an input operation of a operator using as the origin the symbol displayed on the work monitor screen and displaying a work area block model showing the work area.

### TECHNICAL FIELD

The present invention relates to a work area setting and managing system, more particularly, relates to a work area setting and managing system eliminating the management office for preparing work plans and issuing instructions and enabling an operator to set and manage the construction work area at the work site at just a mobile work machine side.

### BACKGROUND ART

For example, antipersonnel land mines have been disposed of in the past by manual work. Specifically, a land mine search device fixed on a long pole similar to that of a metal detector is used to search for one mine at a time. When finding one, water is poured on the ground to soften it, the status of the land mine is checked, a brush etc. is used to clear away the soil to make the land mine visible, then an explosive charge is set and the mine is exploded. Such land mine disposal relies on the experience and intuition of a person with specialized technical expertise, is time consuming, and is poor in work efficiency.

Therefore, the inventors previously proposed a method and system enabling mechanical land mine disposal and managing land mine search data and land mine disposal data for enabling efficient land mine disposal work (Japanese Patent Application No. 2003-31602, filed on Feb. 7, 2003). With this method of land mine disposal work, the work planner utilizes the work planning functions provided in a server PC (personal computer) set in a management office established on the work site so as to prepare a plan and the plan is used as the basis for the land mine disposal work. The work plan is prepared by setting a broad square work area of for example 1 to 2 km a side, overlaying a local map or status of buried land mines and status of disposed land mines on the work area, dividing the work area into square blocks of 50 m or 100 m a side, and designating individual blocks as work area parts for individual work days. The information relating to the prepared work plan is stored as block information of the work area in a memory card or other storage medium and given by the work planner to the operator. The operator sets the storage medium in a PC mounted at the work machine vehicle, starts up the PC, displays the block information for work that day on the display unit, and performs the designated range of land mine disposal work based on the displayed block information. The result of the work is managed as mesh data. When the work ends, the operator inputs the results of the work to reflect it back into the block information of the storage medium and update the block information. After finishing each day's work, the operator takes out the storage medium with the updated block information from the vehicle-mounted PC and returns it to the worker planner. The work planner sets the returned storage medium in the server PC, calls up the data relating to the work area block information stored there, checks the results of that day's work, and uses it to manage the work results.

With this method of land mine disposal work, in managing the work, it is necessary to set up a management office and provide a work planner and a server PC provided with work planning functions. With long work, large work areas, and other large scale work, such a method of land mine disposal work is effective since the management data is enormous.

On the other hand, in the case of relatively small-scale work, setting up a management office etc. is costly. There is room for further study in terms of cost. Further, there are direct demands for eliminating management offices and enabling work management by just the work machine sides.

Further, as prior art on the work management, for example Patent Document 1 (Japanese Patent Publication (A) No. 2002-256555) proposes a work management device. This work management device is provided on a foundation improving work attachment or laying pile work attachment. This work management device is provided with a communication unit for the transfer of targets on the work prepared by the management office and data stored in the attachment by mobile phone via the Internet, a display unit for comparing information from a detection device detecting a rate of descent of the auger during the work and the flow rate of foundation improving agents with the target values and correcting and controlling the same, and a storage unit for storing the target values and data on the work. The target values prepared by the management office are determined based on the status of the foundation of the work site and design values and past data. The target values in the foundation work include the depth of excavation, the ratio of composition and amount of supply of the foundation improving agent at each depth, the amount of supply of the foundation improving agent per hour, the speed of the auger, the rate of ascent and descent, etc. The target values in the lying pile work include the speed, rate of driving, torque, etc. of the pile set based on the depth of installation and the final torque of installation.

With the conventional work management device as well a management office is set and the management office prepares the target values. The target values are input into a personal computer (PC) installed in the management office. The target values input to the PC in the management office are provided to and stored at the work management device at the attachment by connecting that PC and the work management device via a mobile phone and the Internet. Therefore, while the methods of transfer of data differ, this art is similar to the above-mentioned method and system of land mine disposal work in the provision of a management office etc. Therefore, the above conventional work management device did not solve the problem of the establishment of a management office etc. Further, it could not meet the demands for eliminating the management office and enabling work management at just the work machine side.

Patent Document 1: Japanese Patent Publication (A) No. 2002-256555

### DISCLOSURE OF THE INVENTION

### Problem to be Solved by the Invention

The problem of the present invention is to eliminate the management office, server PC provided with work planning functions, etc. and enable work management by just the mobile work machine side in the case of land mine disposal work or other work by land mine disposers or other mobile work machines and for example relatively small scale work.

An object of the present invention, in view of the above problem, is to provide a work area setting and managing system eliminating the management office, server PC having the work planning functions, etc., enabling the operator to plan and manage work at the work area at the work site by just the mobile work machine side, and enabling the work area to be set and stored and the management information to be stored at the work site.

### MEANS FOR SOLVING THE PROBLEM

The work area setting and managing system according to the present invention is configured as follows to achieve the above object.

The work area setting and managing system according to the present invention is a work area setting and managing system for a mobile work machine performing predetermined work in a set work area and provided with a GPS 3D position finding system, a computer having a display unit, input unit, and memory, various movable part sensors, various operation switches, a work start switch, and various trigger switches. The work area setting and managing system is provided with a first means for displaying a work monitor screen on a screen of the display unit, a second means for displaying a symbol of the mobile work machine on the work monitor screen based on positional coordinates of an attachment of the mobile work machine obtained by the GPS 3D position finding system, and a third means for preparing a work area based on an input operation of an operator using as the origin the symbol displayed on the work monitor screen and displaying a work area block model showing the work area, work information relating to the work area being set and managed at just the mobile work machine side based on this.

In this work area setting and managing system, using a computer etc. mounted at the mobile work machine, the operator can set and manage the range of the work area of predetermined work to be performed on individual days by just the mobile work machine side. With this configuration, at the mobile work machine vehicle, the computer display unit displays the work monitor screen, that work monitor screen displays a symbol showing the position of the mobile work machine based on the position of its attachment, and the work monitor screen displays the required work area with that symbol as the origin position. Due to this, the work area for that day can be determined and set by the operator at the work site.

In the work area setting and managing system according to the present invention, in the above configuration, preferably the memory stores a work monitor screen preparation program. This work monitor screen preparation program includes program execution functional parts for realizing the functions of the first means, second means, and third means.

In the work area setting and managing system according to the present invention, in the above configuration, preferably the memory stores a pre-work start object file, the pre-work start object file is read out to the display unit at the start of predetermined work, desired dimensional data relating to the range of the work area to be worked on is input via the input unit, and the work area is determined based on this dimensional data. With this configuration, the range of the work area can be freely input and designated by the operator using the computer at the stage before starting the work.

In the work area setting and managing system according to the present invention, in the above configuration, preferably the memory stores a post-work completion object file, and work information is automatically stored in the post-work completion object file after the work on the work area ends.

In the work area setting and managing system according to the present invention, in the above configuration, preferably the memory stores mesh status management information, and a work area block model is stored and expressed by a mesh model.

In the work area setting and managing system according to the present invention, in the above configuration, preferably the work area block model displayed on the work monitor screen is expressed as a mesh model, and the work area block model displayed by a mesh is displayed color-coded in accordance with the work status of each mesh. Due to this configuration, the operator can easily judge the work status.

In the work area setting and managing system according to the present invention, in the above configuration, preferably the work area block model is displayed by setting the origin of the work area as any origin in the four directions from the position of the symbol.

In the work area setting and managing system according to the present invention, in the above configuration, preferably in the work area displayed on the work monitor screen, poles are set at the four corners of an area where predetermined work has been completed to specify a work completion area.

In the work area setting and managing system according to the present invention, in the above configuration, preferably the mobile work machine is a land mine disposer, and the predetermined work is land mine disposal work.

### EFFECTS OF THE INVENTION

According to the present invention, the system displays a work monitor screen on a computer provided at the land mine disposer or other mobile work machine, finds the position of the mobile work machine based on a GPS 3D position finding system and displays a machine symbol display on this work monitor screen based on that position, and displays the work area using the position of this machine symbol display as the origin coordinates, so it is possible to set and manage the work area by operator operation at the work site at just the mobile work machine side. Therefore, there is no need to prepare a work plan and there is no need for a large computer system, management office, or other equipment for preparing a work plan, so the setting and managing system can be constructed at a low cost. Further, the range of the work area can be set by input to the computer as any range at a stage before work start, so the system is high in flexibility and general applicability.

### BEST MODE FOR WORKING THE INVENTION

Below, preferable embodiments of the present invention will be explained with reference to the drawings.

FIG. 1 is a perspective view of a mobile work machine (land mine disposer) used in the present invention and a block diagram showing the configuration of an electronic system provided in the mobile work machine.

In the present embodiment, a mobile work machine 11 is typically formed as a land mine disposer. In the following explanation, therefore the mobile work machine 11 is explained as a “land mine disposer 11”. The land mine disposer 11 is comprised of crawler type hydraulic excavator known as a hydraulic construction machine as a base machine. The land mine disposer 11 is provided with a turret 12, operator's compartment 13, chassis 14, and front attachment 15. The turret 12 is provided on the chassis 14 to be able to turn. The operator's compartment 13 is provided at the front left side of the turret 12. The chassis 14 is a crawler type, but may also be a wheel type. Special bulletproof glass 16 is used for the front glass and floor glass of the operator's compartment 13. Further, a guard 17 made of steel mesh is provided at the front of the operator's compartment 13.

The front attachment 15 has a boom 21 and an arm 22. The boom 21 is attached at the center of the front of the turret 12 to be able to move in the vertical direction. The arm 22 is attached to the front end of the boom 21 to be able to move in the front-back direction. These are driven by a boom cylinder 23 and arm cylinder 24.

The front end of the arm 22 is provided with an attachment holder 25. This holder 25 enables the rotary cutter system 26 shown in FIG. 1 or a skeleton bucket (not shown) to be attached. The rotary cutter system 26 etc. can move in the front-back direction with respect to the arm 22 and is driven by an attachment cylinder 27. Note that the rotary cutter system 26 has a rotary cutter and a rake and crab type blade.

The arm 22 is provided on its side with a radar type explosive search sensor 28. This sensor 28 can move along the side of the arm 29 by a telescopic type extendable arm 29. Further, a search sensor cylinder 30 enables it to rotate with respect to the extendable arm 29.

The land mine disposer 11 is provided with movable part sensors including an angle sensor for detecting the rotation angle between the turret 12 and boom 21 (boom angle), angle sensor for detecting the rotation angle between the boom 21 and arm 22 (arm angle), angle sensor for detecting the rotation angle between the arm 22 and rotary cutter (rotary cutter angle), stroke sensor for detecting the stroke of the extendable arm 29 (extendable arm stroke), angle sensor for detecting the rotational angle between the extendable arm 29 and explosive search sensor 28 (explosive search sensor angle), and inclination sensor for detecting the inclination angle of the turret in the front-rear direction (pitch angle).

Further, the land mine disposer 11 is provided with two GPS antennas 42, 43 for receiving signals from a GPS satellite 41, a wireless antenna 45 for receiving correction data from a GPS base station 44, and a wireless antenna 46 for sending measurement data. The two GPS antennas 42, 43 are provided at a predetermined interval from each other at the left and right of the rear of the turret 12.

An electronic system 50 is mounted near the operator's compartment 13 of the vehicle body of the land mine disposer 11. The electronic system 50 has the function of a vehicle-mounted measurement system for finding the position and posture of the land mine disposer 11 by the GPS and the function of a work area setting and managing system for setting and managing a work area for land mine disposal work based on a computer and operator instructions at just the land mine disposer 11 side.

The electronic system 50 includes the above-mentioned various plurality of movable part sensors 51, a wireless unit 52 for receiving correction data from the GPS base station 44 through an antenna 45, a distributor 53 for distributing correction data received by the wireless unit 52, GPS receivers 54, 55 using correction data distributed by the distributor 53 and signals from the GPS satellite 41 received by the GPS antennas 42, 43 to calculate the 3D positions of the GPS antennas 42, 43 in real time, an operating switch 56 for turning the explosive search sensor 28 on and off, an operating switch 57 for turning the rotary cutter on and off, a trigger switch for input of the fact of detection of an antipersonnel land mine as a result of a search, a trigger switch for input of the fact of detection of an antitank land mine, a trigger switch for input of the fact of detection of unexploded munitions, and various other trigger switches 58, and a work start switch 59.

Further, the electronic system 50 includes a controller 61 comprised of a microcomputer etc. and a tablet computer 62 constituting a vehicle-mounted PC (personal computer). The controller 6 receives as input position data from the GPS receivers 54, 55, detection data from the various movable part sensors 51, and instruction data from the various operating switches 56, 57, various trigger switches 58, and work start switch 59 and performs the required processing. The tablet computer 62 uses the data obtained by the processing at the controller 61 to compute the position and posture of the land mine disposer 11, the position of the explosive search sensor 28, and the position of the rotary cutter, uses these results to manage the information relating to the work area, and displays the status of the work area and the status of the land mine disposer 11. The tablet computer 62 is itself provided with a board type display unit 63 and input unit 64 and further has a built-in memory 65. Note that as the vehicle-mounted PC, instead of the tablet computer 62, it is also possible to use a vehicle-mounted notebook PC etc. having similar functions.

In the configuration of the electronic equipment 50, the tablet computer 62 is operated by an operator riding the land mine disposer 11 and operating the land mine disposer 11 to perform the land mine disposal work. While performing the land mine disposal work the operator also uses and operates the tablet computer to set and manage the construction work area. Due to this, according to the work area setting and managing system according to the present embodiment, it is possible to set and manage the work area to be worked on each day at the work site by just the mobile land mine disposer 11 side.

Next, the content of the data used for the setting and management of the work area will be explained for land mine disposal work performed by a land mine disposer 11. This data is input to the tablet computer 62 through the input unit 64 or output for display at the display unit 63 and is stored and managed in the memory 65. FIG. 2 to FIG. 4 show the data fields of the managed data.

FIG. 2 shows the pre-work start object file 71. Each of the plurality of data fields shown in the pre-work start object file 71 has to be filled in by input to the tablet computer 62 before the start of work. The operator operates the input unit 64 of the tablet computer 62 manually for the input. The input pre-work start object file 71 is stored in the memory 65.

FIG. 3 shows the post-work completion object file 72. The content of the data fields of the post-work completion object file 72 is the same as the data fields of the pre-work start object file 71. Since the data is of the state post-work completion, the data fields include data which is changed or added to. The post-work completion object file 72 is prepared during the work or after the completion of the work by automatic input by the tablet computer 62. The prepared post-work completion object file 72 is stored in the memory 65.

FIG. 4 shows the mesh status management information 73. The mesh status management information 73 is expressed in a data format for display of the status of each mesh as a result of the work on the set successful work area color coded in accordance with the status of progress of the work. Here, the “mesh” is means the smallest composite unit of the work area and also the smallest unit in data management.

In the management of data relating to the work area, the management is performed using the above concept of a mesh and further the concepts of a block, area, and group. These are managed using a hierarchical structure. A block is comprised of mesh units, an area is comprised of block units, and a group is comprised of area units. One mesh is for example a square planar surface of 50 cm a side, while one block is for example a square planar surface of 100×100 meshes and 50 m a side. Usually, in a tablet computer 62, this range of data is managed. One area is for example a square planar surface of 10×10 blocks and 500 m a side, while one group is for example a range of as much as 100 areas. The range of a group or area is usually covered and managed by one location of a base station.

In the management information 73 of the mesh status shown in FIG. 4, “1. safe area (work not required)”, “2. not yet worked on area”, “7. pre-cleared area”, “8. treated area”, “9. finally cleared area”, “10. underground explosives present” are managed as data content in a text format.

FIG. 5 shows the structure of the management memory area 81 in the memory 65 of the data managed by the tablet computer (in FIG. 5, shown as “vehicle-mounted PC”) 62. The management memory area 81 is provided with memory areas of an object file storage folder 82, a mesh status file storage folder 83, and a work area block model storage folder 84. The object file storage folder 82 stores and manages the above-mentioned pre-work start object file 71 and post-work completion object file 72 for each work day. The mesh status file storage folder 83 stores and manages the above-mentioned mesh status management information (mesh status file) 73 for each work day. The work area block model storage folder 84 stores data on the work area block model showing the work area in the files for each dimension of the work area.

FIG. 6 to FIG. 10 show examples of the basic screen displayed on the screen of the display unit 63 of the tablet computer 62. FIG. 6 shows the work monitor screen, while FIG. 7 to FIG. 10 show examples of the screens displayed when setting the work area at that work monitor screen.

As shown in FIG. 6, the work monitor screen 90 is comprised of a machine symbol display 91 displaying the position of the land mine attachment 11 at the screen area 90A by a symbol-like model image, a work information display 92 outputting work day information etc., a vehicle body information display 93 displaying the status of the GPS, a land mine detection and disposal information display 94 displaying the status of detection and disposal of land mine, a work area button 95 setting the work area, a work end button 96 outputting a work end trigger, and an end button 97 ending the application as a whole. The work monitor screen 90 is prepared and displayed based on the running of a work monitor screen preparation program included in the image display program stored in the memory 65 of the tablet computer 62. The display of the screen content described below is also based on image display function programs included in the image display program.

The example of the screen shown in FIG. 7 and FIG. 8 is a screen setting the work area display in the screen area 90A of the work monitor screen 90. FIG. 7 shows a northeast position setting display screen where the work area display 101 is set to the northeast position with respect to the machine symbol display 91 at the screen area 90A. In the actual positional relationship, therefore, the work area is set at the northeast position with respect to the land mine disposer 11. In the work area display 101 displayed at the screen area 90A, the twenty blocks 102 are the work area blocks set by that work area. This means the display of the work area based on the work area block model. FIG. 8 shows basically the same configuration as the display content shown in FIG. 7. The point of difference is that in the screen area 90A, the work area display 101 is set to the northwest position with respect to the machine symbol display 91. The example of the screen of FIG. 8 is the northwest position setting display screen. In the actual positional relationship, therefore, the work area is set at the northwest position with respect to the land mine disposer 11.

Further, the example of the screen of FIG. 9 is similarly the southeast position setting display screen where the work area display 101 is set to the southeast position in the screen area 90A of the work monitor screen 90 when setting the work area to the southeast position. Further, the example of the screen of FIG. 10 is similarly the southwest position setting display screen where the work area display 101 is set to the southwest position in the screen area 90A of the work monitor screen 90 when setting the work area to the southwest position.

FIG. 11 is a flow chart showing by a flow of steps a construction work area setting and managing method and work information managing method which an operator can utilize by operating a tablet computer 62 etc. at a mobile land mine disposer 11 side at the work site. The work area setting and managing method and work information managing method executed at just the land mine disposer 11 side will be explained referring to the flow chart of FIG. 11 and the above-mentioned FIG. 1 to FIG. 10. Note that the program for executing the processing shown in the flow chart of FIG. 11 is stored as a work area setting and managing program in the memory 65.

The operator sitting in the operator's compartment 13 of the land mine disposer 11 first operates the input unit 64 of the tablet computer 62 to make the display unit 63 display data fields relating to the pre-work start object file 71 shown in FIG. 2, uses those data fields to input the dimensions of the work area to be worked on and the dimensions of the mesh, and stores this file in the corresponding memory area of the corresponding work day of the management memory area 81 shown in FIG. 5 (step S11). Next, the operator starts up the application software for setting and managing the work area (step S12).

At step S13, the pre-work start object file 71 shown in FIG. 2 is read. As a result, it is set at the memory area corresponding to the application software started up using as parameters the dimensions of the range of the work area and the mesh information set by the operator in advance at step S11.

At the next step S14, processing is performed to calculate the position and posture of the land mine disposer 11 from the position information of the two GPS's 54, 55 based on the GPS antennas 42, 43 and posture information of the posture sensors etc. After this, the display screen of the display unit 63 of the tablet computer 62 displays the work monitor screen 90 shown in FIG. 6 (step S15), then at the next step S16, the current position of the land mine disposer 11 shown in FIG. 1 is displayed, based on the position and posture information calculated at step S14, at the screen area 90A of the work monitor screen 90 by the display of the machine symbol display 91 as a symbol-like model image.

Next, at step S17, the operator moves the land mine disposer 11 to the position where work is desired to be started and sets the position of the rotary cutter of the rotary cutter system 26 to the ground.

At step S18, a work area setting button 95 of the work monitor screen 90 shown in FIG. 6 etc. is used to determine the origin position of the work area and determine the direction of the start position based on the position of the land mine disposer 11 shown in FIG. 1. Due to this, the work area for the start of work by the land mine disposer 11 is set and, in the positional relationship of the land mine disposer 11, it is determined which of the northeast position, northwest position, southeast position, or southwest position the origin position of the work area is to be set to.

At step S19, based on the origin position of the work area determined at step S18, from information on the range of the work area to be worked on preset at step S11, the corresponding work area block model is read from the work area block model storage folder 84 of the management memory area 81 in the memory 65 of the tablet computer 62 shown in FIG. 5. A work monitor screen based on this is displayed. This work monitor screen is a work monitor screen as shown in any of FIG. 7 to FIG. 10.

At the next stage, the operator pushes the work start trigger switch 59 shown in FIG. 1 to start the work. At step S20, it is judged if the work start trigger switch 59 has been pushed. If the result at the judgment step S20 is YES, the routine shifts to the next step S21, while when NO, the routine returns to step S18 where steps S18 and S19 are repeated.

At step S21, the positional coordinates of the origin of the set work area block are found from the coordinates of the center position of the rotary cutter. Further, the positional coordinates of the origin are stored in the post-work completion object file 72 shown in FIG. 3. Due to this, work on the work area can be started.

While the land mine disposal work continues, the mesh status showing the land mine disposal and search status is stored and updated to the mesh status shown in FIG. 4 (step S22). The mesh status is judged by making an overall judgment of the status of the land mine disposer 11, the status of the various switches, and the status of the mesh passed through and the mesh status is stored and updated. Next, at step S23, the work status of the mesh is displayed color coded at the screen area 90A of the work monitor screen 90.

At the judgment step S24, it is judged if the operator has operated the work end button 96 shown in FIG. 7 etc. causing a work end trigger to be received. When the result of the judgment step S24 is YES, the routine proceeds to the next step S25, while when NO, the land mine search and disposal work is continued, so steps S22, S23 are performed again. While the land mine disposal work is being performed by the land mine disposer 11, step S22 and step S23 are repeated.

When the operator operates the work end button 96 shown in FIG. 7 etc. and as a result the result of the judgment step S24 becomes YES, the system automatically records the work results in the post-work completion object file 72 of FIG. 3 and stores this in the memory area corresponding to the object file storage folder 82 in the of management memory area 81 of FIG. 5 (step S25). After this, the operator places poles at the four corners of the work area where the land mine disposal work has been completed so as to clearly indicate the work completion area (step S26).

Next, at the judgment step S27, when setting a new work area and continuing with the land mine disposal work (land mine search and disposal), the routine returns to step S18 whereupon steps S18 to S26 are repeated. Further, when ending the land mine disposal work, at step S28, the operator presses the end button 97 shown in FIG. 7 etc. and ends the running of the application software.

As clear from the above explanation of the embodiments, according to the work managing method relating to land mine disposal work of a land mine disposer 11 according to the present embodiment, that is, the system employing the method of setting and managing the work area and the method of managing work information, data relating to the work area can be managed at just the land mine disposer 11 side and the work area can be set in just the work machine, so the construction of the system is easy and the cost can be lowered. Further, since poles are placed clearly indicating the work completion area after completion, outsiders can understand where the safe areas are, which thereby leads to an improvement of safety.

In the above embodiments, the explanation was given of the example of land mine disposal work by a land mine disposer, but the application of the work area management system according to the present invention is not limited to this. Other machines can be used as the work machines needless to say. For example, as the front attachment, a excavator type mechanical part or roller compactor may be provided. In particular, the invention may be applied to management of the compacting by a roller compactor.

The configurations, shapes, sizes, and positional relationships explained in the above embodiments are only shown schematically to an extent enabling understanding and working of the present invention. Therefore, the present invention is not limited to the explained embodiments and can be modified in various manners so long as not departing from the scope of the technical ideas shown in the claims.

### INDUSTRIAL APPLICABILITY

The present invention may be utilized for setting and managing a work area to be worked on at a daily basis by just the vehicle side at the work site for disposal work by a land mine disposer searching for land mines and removing land mines and for other construction work by other construction work machines.

### BRIEF DESCRIPTION OF THE DRAWINGS

FIG. 1 is a diagram of the overall configuration of a typical embodiment of a work area setting and managing system according to the present invention comprised of a land mine disposer and electronic equipment and a GPS mounted in the same.

FIG. 2 is a table showing the content of a pre-work start object file managed by the work area setting and managing system at a land mine disposer side.

FIG. 3 is a table showing the content of data of management information of the post-work completion object file managed by the land mine disposer side in the work area setting and managing system.

FIG. 4 is a table showing the content of data of mesh status management information managed by the land mine disposer side in the work area setting and managing system.

FIG. 5 is a diagram of the storage system showing the structure of data managed by a memory of a vehicle-mounted computer of a land mine disposer in the work area setting and managing system.

FIG. 6 is a screen view showing a work monitor screen displayed on the display unit of a vehicle-mounted computer of a land mine disposer.

FIG. 7 is a screen view showing a first example of the display of a work monitor screen displayed on the display unit of a vehicle-mounted computer of a land mine disposer.

FIG. 8 is a screen view showing a second example of the display of a work monitor screen displayed on the display unit of a vehicle-mounted computer of a land mine disposer.

FIG. 9 is a screen view showing a third example of the display of a work monitor screen displayed on the display unit of a vehicle-mounted computer of a land mine disposer.

FIG. 10 is a screen view showing a fourth example of the display of a work monitor screen displayed on the display unit of a vehicle-mounted computer of a land mine disposer.

FIG. 11 is a flow chart of the routine executed by the work area setting and managing system according to the present embodiment.

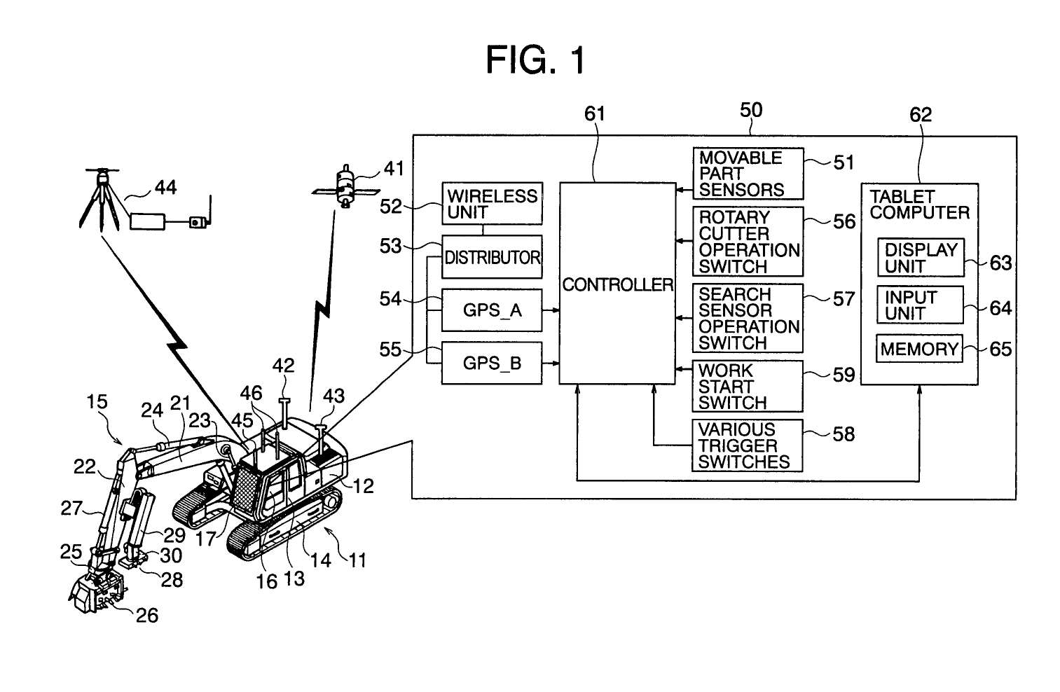

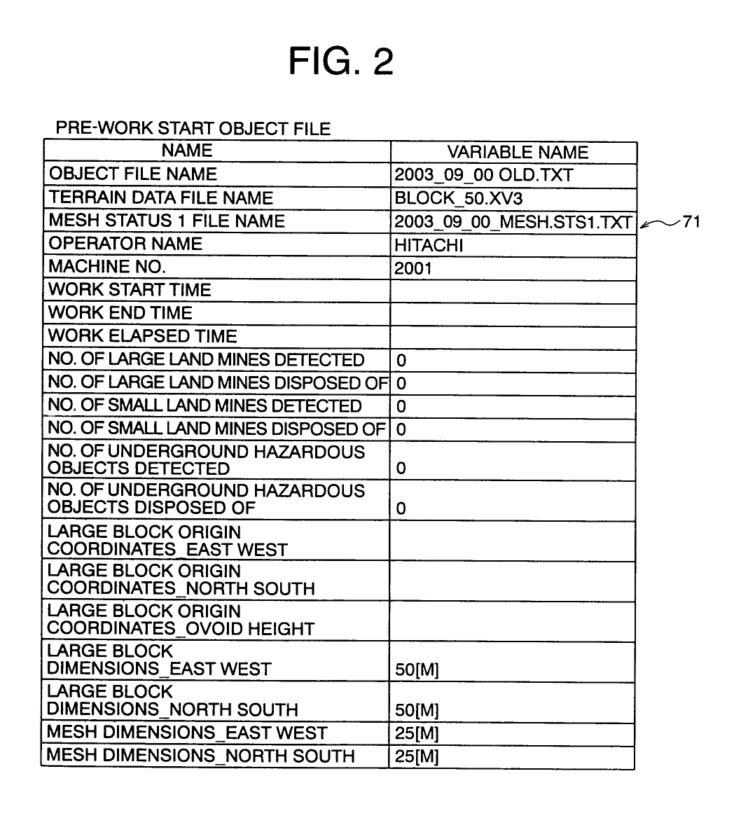

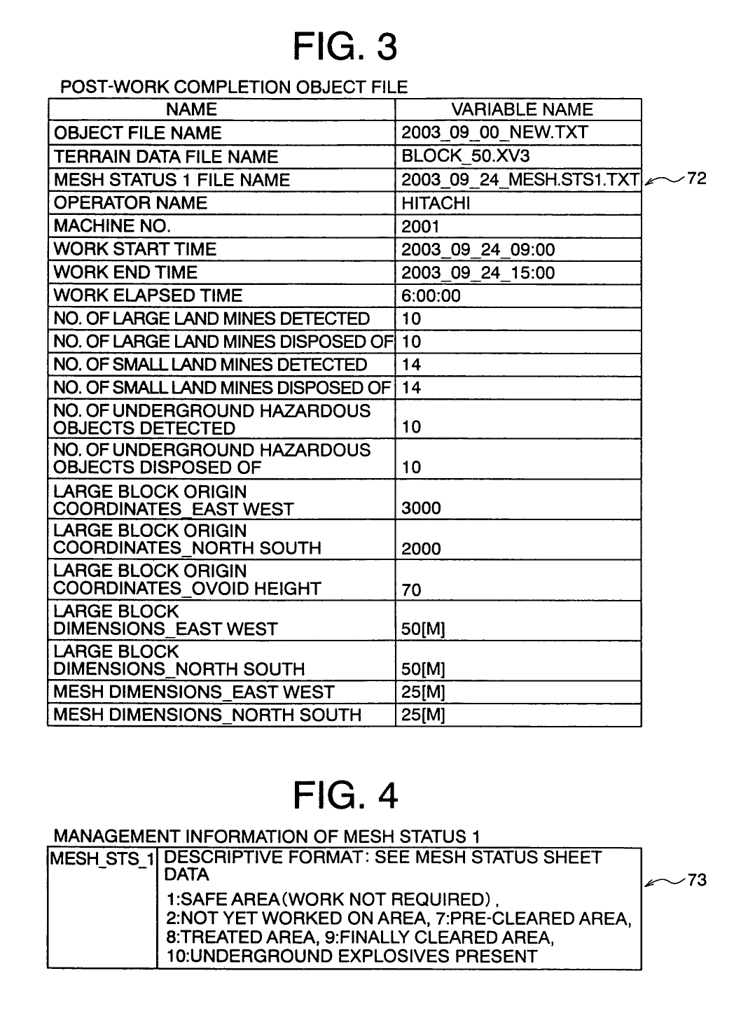

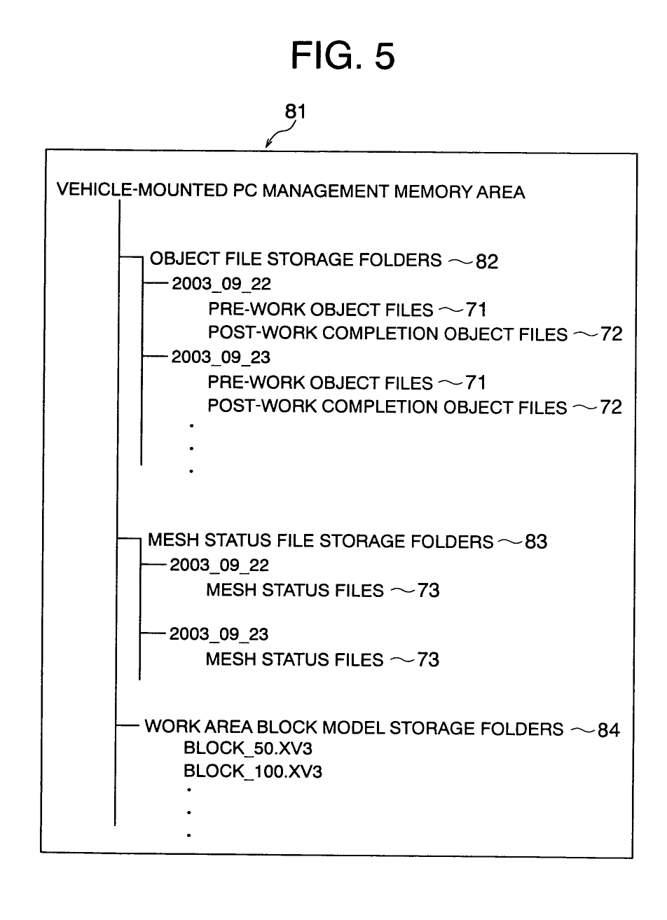

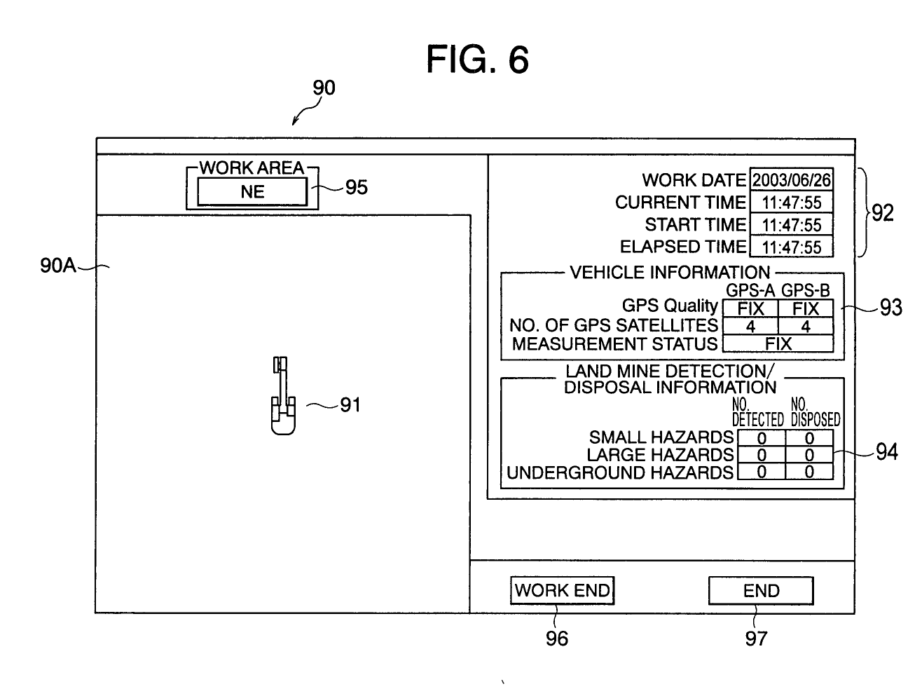

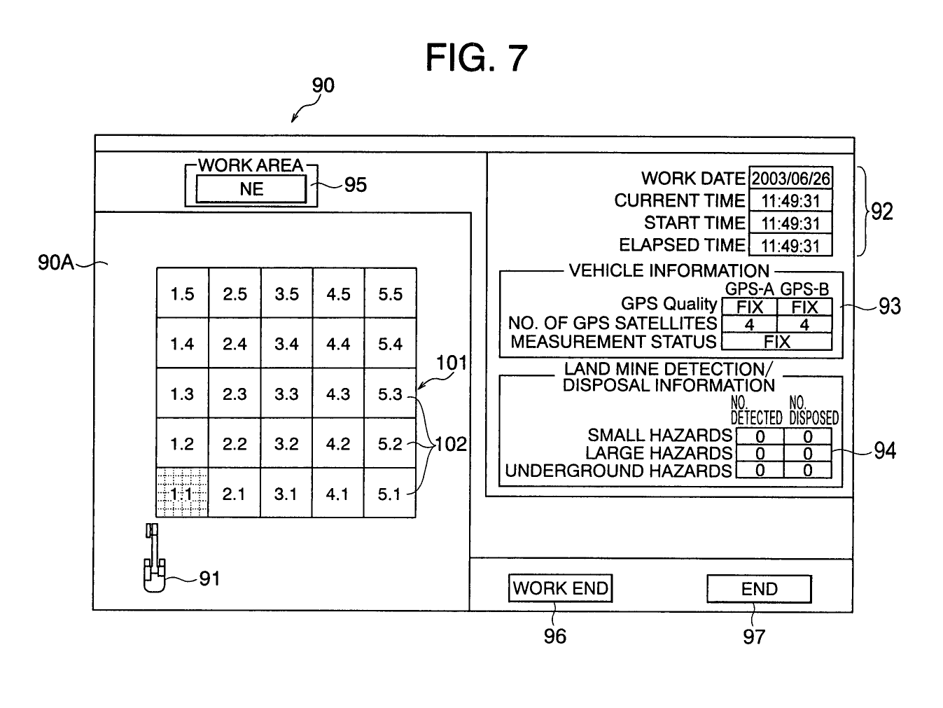

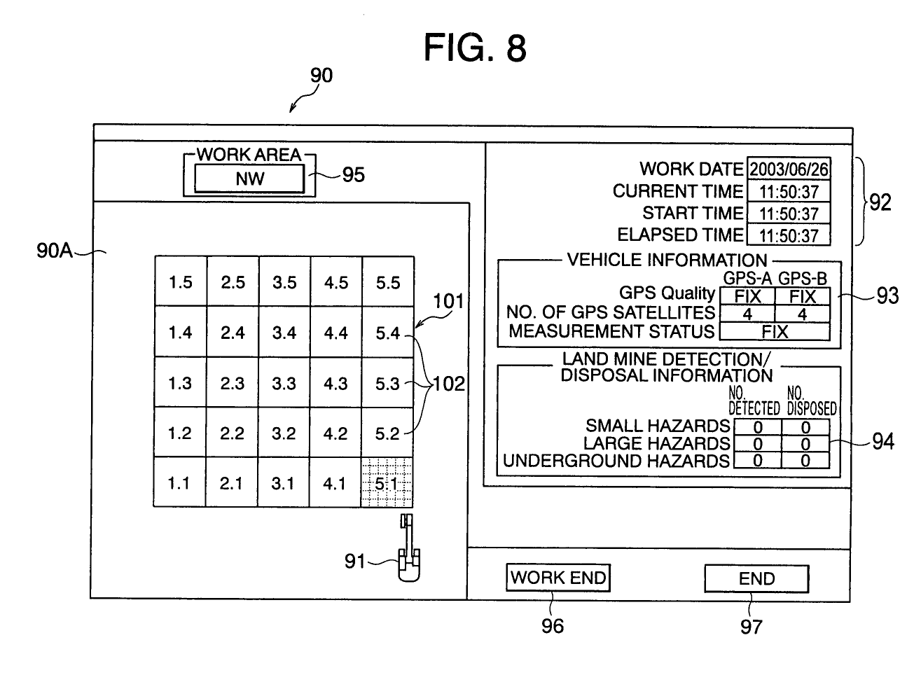

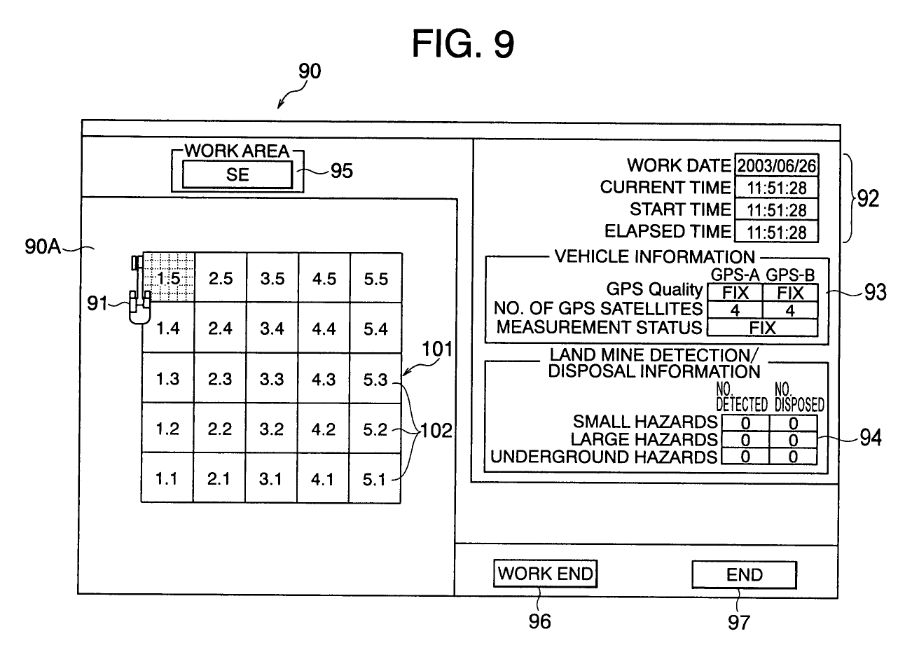

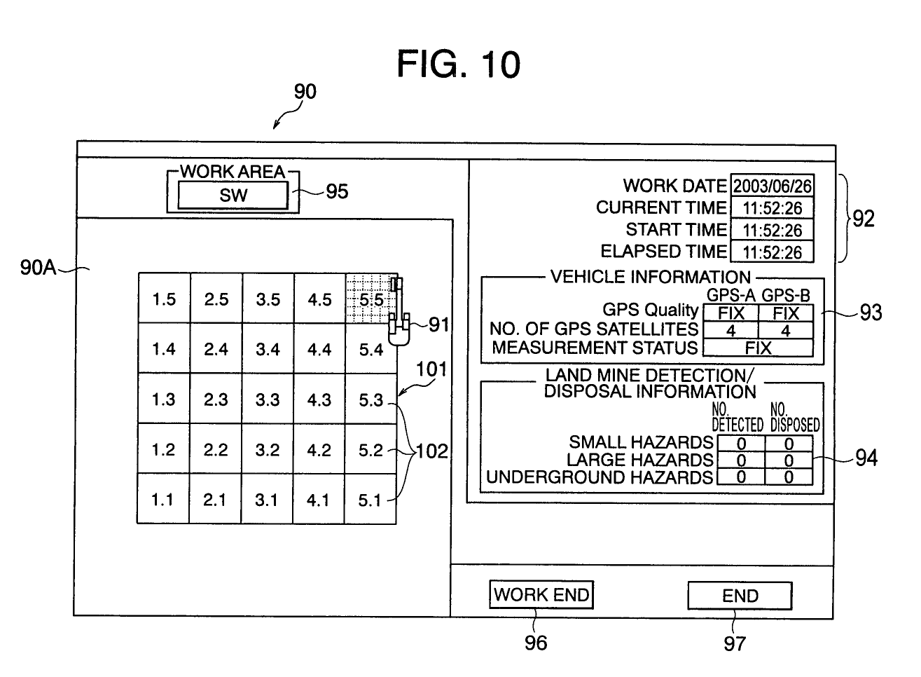

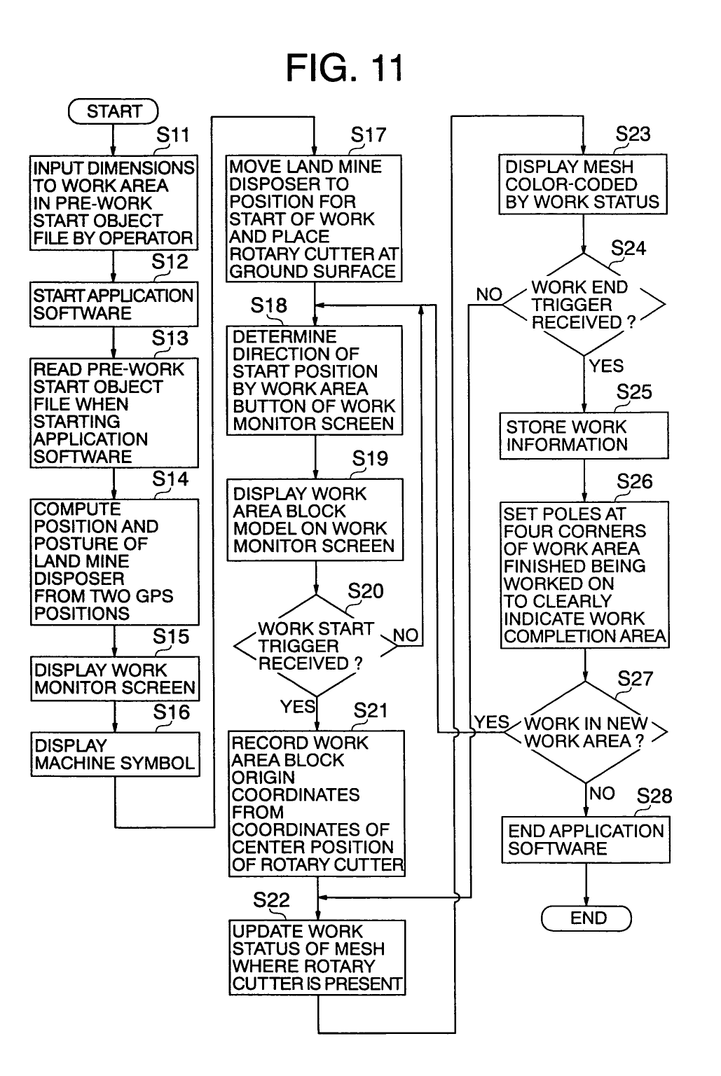

### DESCRIPTION OF NOTATIONS

11 mobile work machine (land mine disposer)
12 turret
13 operator's compartment
14 chassis
15 front attachment
26 rotary cutter apparatus
28 explosive search sensor
41 GPS satellite
44 GPS base station
90 work monitor screen
91 machine symbol display
101 work area display
102 work area block

1. A work area setting and managing system for a mobile work machine performing predetermined work in a set work area and provided with a GPS 3D position finding system and a computer having a display unit, input unit, and memory, characterized in being provided with
a first means for displaying a work monitor screen on a screen of said display unit,
a second means for displaying a symbol of said mobile work machine on said work monitor screen based on positional coordinates of an attachment of said mobile work machine obtained by said GPS 3D position finding system, and
a third means for preparing a work area based on an input operation of an operator using as the origin the symbol displayed on said work monitor screen and displaying a work area block model showing said work area,
wherein work information relating to said work area is set and managed at just the mobile work machine side.

2. A work area setting and managing system as set forth in claim 1, characterized in that said memory stores a work monitor screen preparation program, and said work monitor screen preparation program includes functional parts for realizing said first means, said second means, and said third means.

3. A work area setting and managing system as set forth in claim 1, characterized in that said memory stores a pre-work start object file, reads out on said pre-work start object file on said display unit at the time of start of said predetermined work, has obtained dimensional data relating to the range of the work area for the work input through said input unit, and determines the work area based on the dimensional data.

4. A work area setting and managing system as set forth in claim 1, characterized in that said memory stores a post-work completion object file and automatically stores work information in said post-work completion object file after work in said work area is ended.

5. A work area setting and managing system as set forth in claim 1, characterized in that said memory stores mesh status management information, and said work area block model is stored and expressed by a mesh model.

6. A work area setting and managing system as set forth in claim 5, characterized in that said work area block model displayed on said work monitor screen is expressed by a mesh model, and said work area block model displayed by a mesh is displayed color-coded in accordance with the work status of each mesh.

7. A work area setting and managing system as set forth in claim 1, characterized in that said work area block model is displayed by setting an origin of said work area as any origin in four directions from the position of said symbol.

8. A work area setting and managing system as set forth in claim 1, characterized in that in said work area displayed on said work monitor screen, poles are set at the four corners of an area where said predetermined work has been completed to specify a work completion area.

9. A work area setting and managing system as set forth in claim 1, characterized in that said mobile work machine is a land mine disposer, and said predetermined work is land mine disposal work.
